(19) United States
(12) Patent Application Publication
(10) Pub. No.: US 2018/0088349 A1
(43) Pub. Date: Mar. 29, 2018

(54) COMBINATION OF IMAGE DISPLAY DEVICE AND DIFFRACTIVE OPTICAL FILTER AND MANUFACTURING METHOD OF THE SAME

(71) Applicant: NALUX CO., LTD., Osaka (JP)

(72) Inventors: Yosuke SAKOHIRA, Osaka (JP); Daisuke SEKI, Osaka (JP); Makoto OKADA, Osaka (JP)

(21) Appl. No.: 15/828,492

(22) Filed: Dec. 1, 2017

Related U.S. Application Data
(63) Continuation of application No. PCT/JP2015/086002, filed on Dec. 24, 2015.
(60) Provisional application No. 62/187,337, filed on Jul. 1, 2015.

(51) Int. Cl. G02B 27/46; G02B 5/20; G02B 5/18; H04N 9/64

(52) U.S. Cl. CPC G02B 27/46; H04N 9/64; G02B 5/18; G02B 5/20

(57) ABSTRACT

A combination of a color image display device and a diffractive optical filter, the color image display device including dots arrayed two-dimensionally on a first surface, the diffractive optical filter including a diffraction grating provided on a second surface that is parallel to the first surface, and a cross section in each direction of the diffraction grating being of substantially sinusoidal shape, wherein the combination is configured such that it can restrain the screen-door effect and isolation of dots to a sufficient extent and/or such that it can restrain moiré that appears according to the pitches between pixels and the period of the diffraction grating of the diffractive optical filter.

### BACKGROUND

### Technical Field

The present invention relates to a combination of an image display device and a diffractive optical filter and a manufacturing method for the combination of a diffractive optical filter and an image display device.

### Description of the Related Art

In an image display device in which many pixels are placed regularly in a two-dimensional array, there generally exist portions that do not emit light between pixels. When an image of such an image display device is magnified through a magnifying lens or projected by a projector for observation, an image of the portions that do not emit light between pixels are also magnified and become prominent, and therefore a so-called screen-door effect appears, in which an appearance of the image deteriorates. Further, in a color image display device, each pixel contains dots of plural colors. Dots mean elements constituting a pixel, and the elements are of the three primary colors, that is, red, green and blue. There exist gaps also between dots in a pixel, and therefore it is a problem that at the boundary of colors or at the boundary of light and dark in an image, a dot in a pixel is isolated, and a single dot appears inconveniently recognizable.

In order to solve the problems described above, methods in which images of pixels are made separate and blurred by the use of a diffractive optical filter provide with a diffraction grating are known (Patent documents 1 and 2, for example). However, in order to restrain moiré that appears according to the pitches between pixels and the period of the diffraction grating of the diffractive optical filter, the period of the diffraction grating of the diffractive optical filter has to be determined appropriately.

In order to appropriately separate images of pixels by the use of a diffractive optical filter, a spacing between a surface provided with the diffraction grating and an open surface provided with the pixels and the period of the diffraction grating have to be appropriately determined. In general, members such as a glass or a polarizing plate are attached to the open surface, and therefore the spacing between the surface provided with the diffraction grating and the open surface provided with the pixels cannot be made smaller than the total thickness of the members. Further, recently the number of the pixels of an image display device has increased, and pitches between pixels have become smaller. In order to obtain a desired separation width for a smaller pitch between pixels, the diffraction angle has to be made smaller. As a result, the period of the grating becomes greater. In such a case, in an optical system in which an image of the image display device is magnified through a magnifying lens for observation, unevenness due to diffraction appears in the display, because the diameter of a light beam that passes through the diffractive optical filter is of the order of the pupil diameter of an observer.

When a spacing between the surface provided with the diffraction grating and the open surface provided with the pixels is determined in a conventional combination of an image display device and a diffractive optical filter, a range of the period of the grating is restricted. Accordingly, there has been a possibility that the period of the grating that prevents moiré cannot be selected. Patent document 3 discloses a method in which the diffraction grating is inclined with respect to the array of the pixels. However, an appropriate range of the angle is not set, and therefore moiré cannot be restrained to a sufficient extent for certain ranges of the pitch between pixels and the period of the grating.

Further, conventionally, the shape of a diffraction grating has been designed for the central wavelength of lights (mainly that of green) used for display. Accordingly, for red dots that have a higher spectral luminous efficiency and a higher resolution to the human eye, the screen-door effect and isolation of dots cannot be restrained to a sufficient extent.

Accordingly, there is a need for a combination of an image display device and a diffractive optical filter that can restrain the screen-door effect and isolation of dots to a sufficient extent and that can restrain moiré that appears according to the pitches between pixels and the period of the diffraction grating of the diffractive optical filter and a manufacturing method of the combination.

### PATENT DOCUMENTS

Patent document 1: JPS63-114475

Patent document 2: JPH02-198921

Patent document 3: JPH09-211392

The object of the present invention is to provide a combination of an image display device and a diffractive optical filter that can restrain the screen-door effect and isolation of dots to a sufficient extent and that can restrain moiré that appears according to the pitches between pixels and the period of the diffraction grating of the diffractive optical filter and a manufacturing method of the combination.

### SUMMARY OF THE INVENTION

In a combination of a color image display device and a diffractive optical filter according to the first aspect of the present invention, the color image display device includes dots arrayed two-dimensionally on a first surface, the diffractive optical filter includes a diffraction grating provided on a second surface that is parallel to the first surface, and a cross section in each direction of the diffraction grating is of substantially sinusoidal shape. A depth dg of the sinusoidal shape is represented as

$${d}_{g} = \frac{ɛλ}{Δ n}$$

where λ represents the wavelength at which intensity of red light used for the image display device reaches the peak, Δn represents a difference in refractive index at λ of the grating, and ε represents a constant, a period p_{g} of the sinusoidal shape is represented as

$${p}_{g} = \frac{k λ L}{α {p}_{p}}$$

$$0.32 < α < 0.39$$

$$5 {P}_{p} < L$$

where L represents a distance between the first surface and the second surface, pₚ represents a dot pitch of a color that is the greatest among the colors, the dot pitch referring to the minimum distance between two adjacent dots of the same color, k is 1 or 3, α represents a constant, when k=1, the relationship

0.445≦ε≦0.465

holds, and when k=3, the relationship

1.15≦ε≦1.25

holds.

In the combination of a color image display device and a diffractive optical filter according to the present aspect, the grating depth and the grating period are determined with respect to red lights and the array of the red dots. Accordingly, the screen-door effect can be restrained to a sufficient extent for red dots that have a higher spectral luminous efficiency and a higher resolution to the human eye.

In a combination of a color image display device and a diffractive optical filter according to a first embodiment of the present aspect, the wavelength λ at which intensity of red light used for the image display device reaches the peak is in the following range.

0.600 [μm]≦λ≦0.660 [μm]

In a combination of a color image display device and a diffractive optical filter according to a second embodiment of the present aspect, the diffractive optical filter is made of synthetic resin and is molded through injection molding.

In a combination of a color image display device and a diffractive optical filter according to the second aspect of the present invention, the color image display device includes dots arrayed two-dimensionally on a first surface, the diffractive optical filter includes a diffraction grating provided on a second surface that is parallel to the first surface, and a cross section in each direction of the diffraction grating is of substantially sinusoidal shape. When a certain dot of a certain color on the first surface is noted, and a vector connecting the noted dot and the dot of the same color closest to the noted dot is referred to as a principal direction vector and represented as

\vec{Pₐ},

among vectors connecting the noted dot and the dot closest to the noted dot in the dots arrayed in rows that are not parallel to

\vec{Pₐ},

the vector that forms an angle that is closest to 90 degrees with

\vec{Pₐ}

is referred to as a sub-direction vector and represented as

\vec{P_{b}},

a vector that is perpendicular to

i\vec{P_{b}}−j\vec{Pₐ},

i and j representing integers that are prime, and that has a magnitude that is equal to the distance between two adjacent straight lines among the straight lines that correspond to rows of dots arrayed in the direction that is parallel to

i\vec{P_{b}}−j\vec{Pₐ},

is represented as

\vec{Pₚ_{ᵢⱼ}},

the vector can be expressed as

$$\vec{{P}_{{p}_{ij}}} = ( \frac{i {\vert \vec{{P}_{b}} \vert}^{2} - j \vec{{P}_{a}} \cdot \vec{{P}_{b}}}{{\vert i \vec{{P}_{b}} - j \vec{{P}_{a}} \vert}^{2}} ) \vec{{P}_{a}} + ( \frac{j {\vert \vec{{P}_{a}} \vert}^{2} - i \vec{{P}_{a}} \cdot \vec{{P}_{b}}}{{\vert i \vec{{P}_{b}} - j \vec{{P}_{a}} \vert}^{2}} ) \vec{{P}_{b}} , \\ {p}_{pij} = \vert \vec{{P}_{pij}} \vert ,$$

Cij is defined as

$${C}_{ij} = \frac{{p}_{{p}_{ij}} {p}_{g}}{2 {a}_{ij} {b}_{ij}} ( {( \frac{{a}_{ij}}{{p}_{{p}_{ij}}} )}^{2} + {( \frac{{b}_{ij}}{{p}_{g}} )}^{2} - {( \frac{1}{2 {p}_{p}} )}^{2} ) ,$$

for any

\vec{Pₚ_{ᵢⱼ}}

that has

aᵢⱼ,bᵢⱼ

that satisfy

$$\frac{1}{2 {p}_{p}} \geq \vert \frac{{a}_{ij}}{{p}_{{p}_{ij}}} - \frac{{b}_{ij}}{{p}_{g}} \vert$$

pₚ representing a dot pitch, that is, the minimum distance between two adjacent dots of the color and

aᵢⱼ,bᵢⱼ

representing natural numbers, and

p_{g}

representing the period of the diffraction grating,
an angle that

\vec{Pₐ}

and each direction of the diffraction grating form is represented as

θ_{g},

and an angle that

\vec{Pₐ}

and

\vec{P_{P}_{ᵢⱼ}}

form is represented as

θₚ_{ᵢⱼ},

the combination is configured such that

θ_{g}<θ_{P}_{ᵢⱼ}−cos⁻¹Cᵢⱼ

or

θ_{g}>θ_{P}_{ᵢⱼ}+cos⁻¹Cᵢⱼ

is satisfied.

In the combination of a color image display device and a diffractive optical filter according to the present aspect, moiré pitch that is generated by the spacing between dot rows and the period of the diffraction grating can be made unrecognizable.

In a combination of a color image display device and a diffractive optical filter according to a first embodiment of the present aspect, the number of

\vec{Pₚ_{ᵢⱼ}}

that has

aᵢⱼ,bᵢⱼ

that satisfy

$$\frac{1}{2 {p}_{p}} \geq \vert \frac{{a}_{ij}}{{p}_{{p}_{ij}}} - \frac{{b}_{ij}}{{p}_{g}} \vert$$

is three or more.

In a combination of a color image display device and a diffractive optical filter according to a second embodiment of the present aspect, the number of

\vec{Pₚ_{ᵢⱼ}}

that has

aᵢⱼ,bᵢⱼ

that satisfy

$$\frac{1}{2 {p}_{p}} \geq \vert \frac{{a}_{ij}}{{p}_{{p}_{ij}}} - \frac{{b}_{ij}}{{p}_{g}} \vert$$

is ten or more.

A manufacturing method of a combination of a color image display device and a diffractive optical filter according to the third aspect of the present invention is a manufacturing method of a combination of the color image display device including dots arrayed two-dimensionally on a first surface and the diffractive optical filter including a diffraction grating provided on a second surface that is parallel to the first surface. A cross section in each direction of the diffraction grating is of substantially sinusoidal shape. The method includes the steps of determining a period and a depth of the sinusoidal shape the diffraction grating; calculating

$$\vec{{P}_{{p}_{ij}}} = ( \frac{i {\vert {\vec{P}}_{b} \vert}^{2} - j \vec{{P}_{a}} \cdot \vec{{P}_{b}}}{{\vert i \vec{{P}_{b}} - j \vec{{P}_{a}} \vert}^{2}} ) \vec{{P}_{a}} + ( \frac{j {\vert \vec{{P}_{a}} \vert}^{2} - i \vec{{P}_{a}} \cdot \vec{{P}_{b}}}{{\vert i \vec{{P}_{b}} - j \vec{{P}_{a}} \vert}^{2}} ) \vec{{P}_{b}} ,$$

when a certain dot of a certain color on the first surface is noted, and a vector connecting the noted dot and the dot of the same color closest to the noted dot is referred to as a principal direction vector and represented as

\vec{Pₐ},

among vectors connecting the noted dot and the dot closest to the noted dot in the dots arrayed in rows that are not parallel to

\vec{Pₐ},

the vector that forms an angle that is closest to 90 degrees with

\vec{Pₐ}

is referred to as a sub-direction vector and represented as

\vec{P_{b}},

a vector that is perpendicular to
i\vec{P_{b}}−j\vec{Pₐ},
i and j representing integers that are prime, and that has a magnitude that is equal to the distance between two adjacent straight lines among the straight lines that correspond to rows of dots arrayed in the direction that is parallel to

i\vec{P_{b}}−j\vec{Pₐ}

is represented as

\vec{Pₚ_{ᵢⱼ}}, and determining

θ_{g}

that satisfies

θ_{g}<θₚ_{ᵢⱼ}−cos⁻¹Cᵢⱼ

or

θ_{g}>θₚ_{ᵢⱼ}+cos⁻¹Cᵢⱼ

where Cij is defined as

$${C}_{ij} = \frac{{p}_{{p}_{ij}} {p}_{g}}{2 {a}_{ij} {b}_{ij}} ( {( \frac{{a}_{ij}}{{p}_{{p}_{ij}}} )}^{2} + {( \frac{{b}_{ij}}{{p}_{g}} )}^{2} - {( \frac{1}{2 {p}_{p}} )}^{2} ) ,$$

for any

\vec{Pₚ_{ᵢⱼ}}

that has

aᵢⱼ,bᵢⱼ

that satisfy

$$\frac{1}{2 {p}_{p}} \geq \vert \frac{{a}_{ij}}{{p}_{{p}_{ij}}} - \frac{{b}_{ij}}{{p}_{g}} \vert$$

pₚ representing a dot pitch, that is, the minimum distance between two adjacent dots of the color

aᵢⱼ,bᵢⱼ

representing natural numbers,

p_{g}

representing the period of the diffraction grating, and

pₚ_{ᵢⱼ}=|\vec{Pₚ_{ᵢⱼ}}|,

an angle that

\vec{Pₐ}

and each direction of the diffraction grating form is represented as

θ_{g},

and an angle that

\vec{Pₐ}

and

\vec{Pₚ_{ᵢⱼ}}

form is represented as

θₚ_{ᵢⱼ}.

B_{y} the manufacturing method of a combination of a color image display device and a diffractive optical filter according to the present aspect, a combination in which moiré pitch that is generated by the spacing between dot rows and the period of the diffraction grating can be made unrecognizable can be manufactured.

### BRIEF DESCRIPTION OF DRAWINGS

FIG. 1 shows an example of an array of dots in an image display device;

FIG. 2 illustrates the screen-door effect and isolation of a pixel or a dot;

FIG. 3 illustrates a diffractive optical filter used to restrain the screen-door effect;

FIG. 4 is a flowchart for illustrating a manufacturing method of a combination of an image display device and a diffractive optical filter according to the present invention;

FIG. 5 illustrates separation width δ;

FIG. 6 shows an array of red dots on the surface of an image display device;

FIG. 7 illustrates

\vec{Pₚ₃₁}

and

θₚ_{₃₁},

for example;

FIG. 8 shows intensity distributions of colors, that is, blue (B), green (G) and red (R) used for image display devices of the examples and the comparative examples;

FIG. 9 shows relationships between angle of the grating and moiré pitch for respective pₚᵢⱼ in Example 1;

FIG. 10 shows relationships between angle of the grating and moiré pitch for respective pₚᵢⱼ in Example 2

FIG. 11 shows relationships between angle of the grating and moiré pitch for respective pₚᵢⱼ in Comparative Example 1;

FIGS. 12A and 12B show images displayed by the combination of the image display device and the diffractive optical filter of Example 1;

FIGS. 13A and 13B show images displayed by the combination of the image display device and the diffractive optical filter of Example 2;

FIGS. 14A and 14B show images displayed by the combination of the image display device and the diffractive optical filter of Comparative Example 2; and

FIG. 15 is a flowchart for illustrating a conventional manufacturing method of a combination of an image display device and a diffractive optical filter.

### DETAILED DESCRIPTION OF EMBODIMENTS

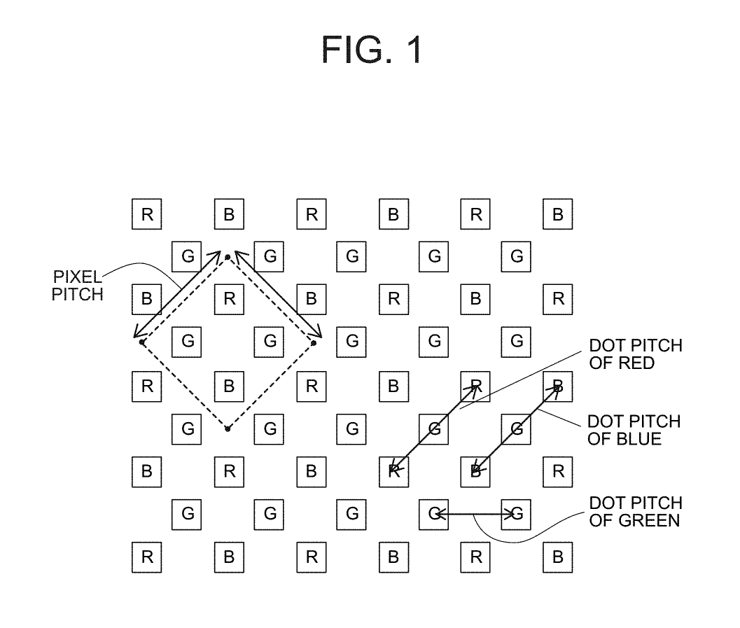

FIG. 1 shows an example of an array of dots in an image display device. In the image display device, dots of the three colors, that is, red, blue and green are used. The dots of the three colors are arranged on a flat surface. The minimum distance between two adjacent dots of the same color is referred to as a dot pitch of the color. In general, the dot pitch of red and the dot pitch of blue is equal to or greater than the dot pitch of green.

In the description of the present specification, a square array (a diamond-shaped array) as shown in FIG. 1 is employed. However, the present invention can be applied also to other types of array including a rectangular array and a hexagonal array, and is not restricted to the square array.

When an observer observes an image display device in which dots are arrayed at predetermined pitches, the screen-door effect appears, by which the observer is apt to feel as if gaps between dots were the mesh of a net. Further, a phenomenon occurs in which at the boundary of colored areas, a pixel or a dot appears to be isolated.

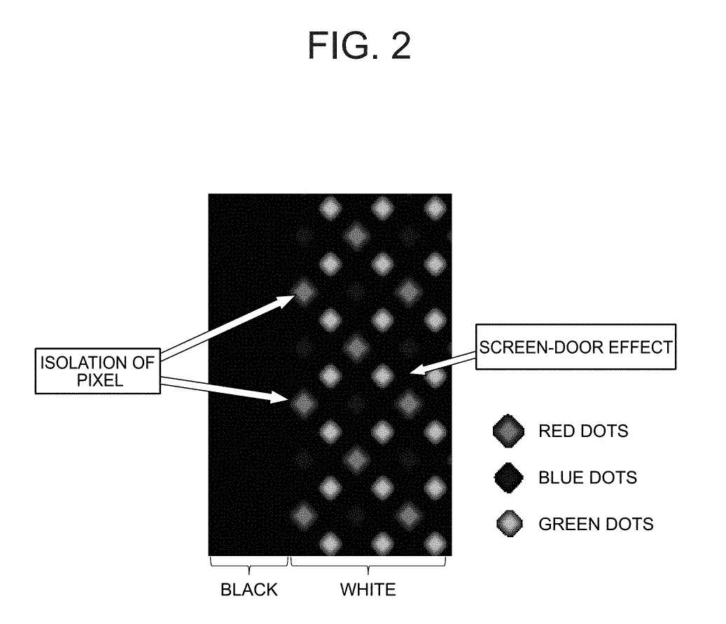

FIG. 2 illustrates the screen-door effect and isolation of a pixel or a dot. In the white area of the image display device, it is felt as if gaps between dots were the mesh of a net. Further, at the boundary between white area and black area, a pixel or a dot appears to be isolated. In order to improve the quality of an image of an image display device, it is required to restrain the screen-door effect and isolation of a pixel or a dot.

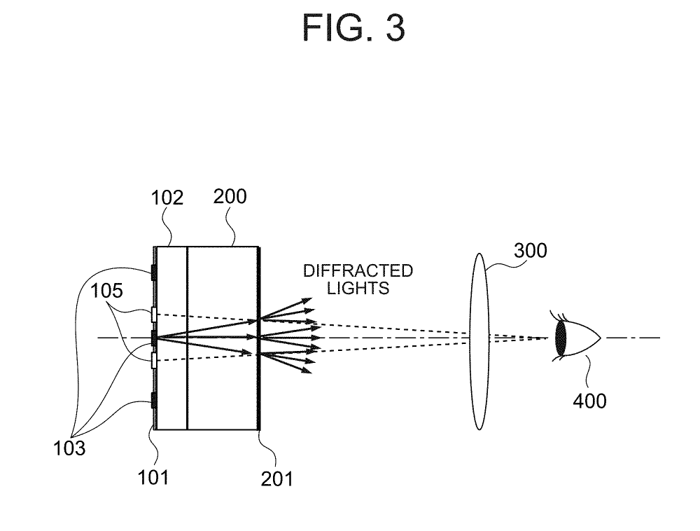

FIG. 3 illustrates a diffractive optical filter used to restrain the screen-door effect. On an open surface 101 of an image display device the whole shape of which is not shown in the drawing, dots 103 are arrayed at predetermined pitches. The open surface 101 is covered by a glass cover 102. Adjacent to the cover 102, a diffractive optical filter 200 is installed. On the side of an observer 400, the diffractive optical filter 200 has a surface 201 provided with a diffraction grating. The surface is referred to as a diffraction grating surface. The observer 400 observes the open surface 101 through the diffractive optical filter 200 and a lens 300. On the open surface 101, images 105 are formed by diffraction of lights emitted by the dots. The images function to restrain the phenomenon in which the observer 400 is apt to feel as if gaps between dots were the mesh of a net, that is, the screen-door effect.

Such diffractive optical filters have been conventionally used. However, conventional diffractive optical filters were not able to restrain the screen-door effect to a sufficient extent. Under the circumstances, the present invention provides a combination of an image display device and a diffractive optical filter that can restrain the screen-door effect to a sufficient extent and a manufacturing method of the combination.

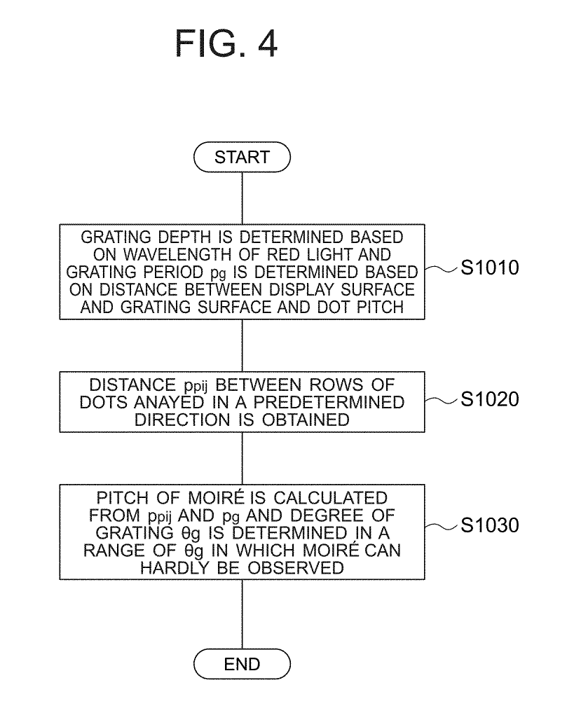

FIG. 4 is a flowchart for illustrating a manufacturing method of a combination of an image display device and a diffractive optical filter according to the present invention.

In step S1010 of FIG. 4, the grating depth and the grating period (grating pitch) are determined. The diffraction grating is of a sinusoidal form.

In general, the dot pitch of red dots is the greatest among dot pitches of the three colors, and red lights have a higher spectral luminous efficiency and a higher resolution to the human eye. Accordingly, when the grating depth and the grating period are determined with respect to red lights and the array of the red dots, the screen-door effect is remarkably restrained. In this case, for green dots, diffraction efficiency of higher order lights is greater than red lights, and therefore, resolution deteriorates to some extent. However, the deterioration is in the acceptable range. Further, for blue dots, diffraction efficiency of higher order lights is even greater. However, since blue lights have a lower spectral luminous efficiency and a lower resolution to the human eye, a slight deterioration in resolution causes no problem in recent image display devices with great pixel number.

Firstly, how to determine the grating depth will be described. The grating depth should preferably be determined such that when at the wavelength λ at which intensity of red light used for display reaches the peak, diffracted lights of up to the k-th order are utilized, intensity of diffracted light of each order is substantially equal to one another and diffracted lights of the (k+1)-th or more order are smaller. k represents an integer. The depth d_{g} of the diffraction grating of a sinusoidal form is represented as below,

d_{g}=ελ/Δn (1)

where Δn represents a difference in refractive index at λ between the both sides of the diffraction grating surface.

When diffraction efficiency of the k-th order light is represented as Ek, diffracted lights of up to the first order are utilized, and ε is set such that the relationship

0.445≦ε≦0.465

holds, E0 and E1 advantageously become substantially equal to each other. When the relationship

ε<0.445

holds, the intensity of an image formed by the first order lights is too small to restrain the screen-door effect to a sufficient extent. On the other hand, when the relationship

ε>0.465

holds, the diffracted lights of the second or more order are so great that images are separated to a greater extent than would be desired, and therefore resolution of the displayed image will deteriorate.

When diffracted lights of up to the second order are utilized and E2 is made greater, E1 becomes relatively great, but E0 becomes excessively small. Accordingly, an image of the zeroth order light disappears so that gaps between images of dots become recognizable.

When diffracted lights of up to the third order are utilized and ε is set such that the relationship

1.15≦ε≦1.25

holds, E0, E2 and E3 advantageously become substantially equal to one another. Although E1 becomes so small that an image of the first order light disappears, images of the zeroth order, the second order and the third order lights remain and gaps between images of dots can be filled to a sufficient extent.

In the case of the fourth or higher order diffracted light, the depth of the diffraction grating is so great that manufacturing a mold for the diffraction grating by lithography becomes difficult.

In summary, when diffracted lights of up to the first order are utilized, e should be set such that the relationship

0.445≦ε≦0.465

holds, and when diffracted lights of up to the third order are utilized, e should be set such that the relationship

1.15≦ε≦1.25

holds.

Secondly, how to determine the grating period will be described.

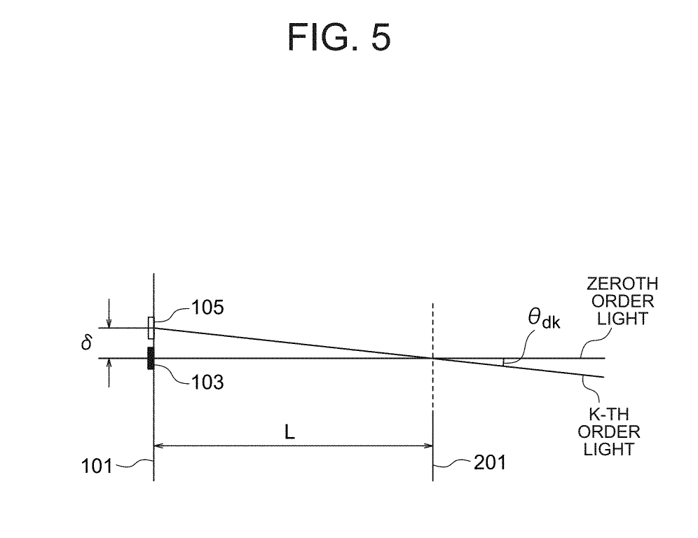

FIG. 5 illustrates separation width δ. Separation width δ is a spacing between an image formed by the k-th order light and an image formed by the zeroth order light.

When separation width δ is represented as

δ=αpₚ,

pₚ represents a dot pitch of the color, with which spacing between dots is the greatest among all colors, α is set such that the relationship

0.32≦α≦0.39

holds, and α is preferably equal to 0.35, unnecessary deterioration in images can be restrained while the screen-door effect is restrained.

When the relationship

α≦0.32

holds, separation of dots is not sufficient, and gaps between adjacent dots is so great that the screen-door effect cannot be restrained to a sufficient extent. When the relationship

α≧0.39

holds, the separation width is excessively great so that resolution of displayed images themselves excessively deteriorates.

The optical distance L [mm] between the diffraction grating surface and the open surface provided with pixels is represented as below.

$$L = {\sum }_{i} \frac{{l}_{i}}{{n}_{i}}$$

lᵢ [mm] represents thickness of the medium placed in the i-th position from the open surface, and nᵢ represents refractive index of the medium.

The diffraction angle θ_{dk} of the k-th order light of the diffraction grating is represented as below by the grating equation when the period of the diffraction grating is represented as p_{g}.

p_{g} sin θ_{dk}=kλ

On the other hand, since the relationship

δ=L tan θ_{dk}

holds as shown in FIG. 5, L can be represented as below.

$$L = \frac{δ}{tan ( {sin}^{- 1} ( k λ \text{/} {p}_{g} ) )} = α {p}_{p} \sqrt{{( \frac{{p}_{g}}{k λ} )}^{2} - 1}$$

The above-described expression can be changed into the following expression.

$${p}_{g} = k λ \sqrt{{( \frac{L}{α {p}_{p}} )}^{2} + 1}$$

When the relationship

L>>αpₚ

holds, the following expression holds through approximation of the expression in the radical sign.

$${p}_{g} = \frac{k λ L}{α {p}_{p}} \qquad ( 2 )$$

In general, a cover glass or the like is attached to an image display device as shown in FIG. 3, and therefore the diffraction grating surface cannot be set at a position nearer to the opening surface than the surface of the cover glass or the like. Further, when a diffractive optical filter is bonded to the image display device, the diffraction grating surface is required to be located on the side opposite to the bonding surface, because effects of diffraction cannot be obtained if refractive index of an adhesive is close to that of the diffractive optical filter. Accordingly, the thickness of the diffractive optical filter itself is included in L. When the diffractive optical filter is manufactured by injection molding, the thickness of the diffractive optical filter should preferably be around 1 mm in order to obtain a low pass filter that has an even thickness and no warp and has a size that is applicable to a relatively large area display device. On the other hand, in a recent image display device with great pixel number, the dot pitch is several hundred micrometers or less. Accordingly, the relationship

L>5pₚ>10αpₚ>>αpₚ

holds, and the precondition of the approximate expression (2) is satisfied.

As described above, depth of the diffraction grating is determined by Expression (1), and period of the diffraction grating is determined by Expression (2).

In step S1020 of FIG. 4, a distance between rows of dots arrayed in a predetermined direction on the open surface is obtained

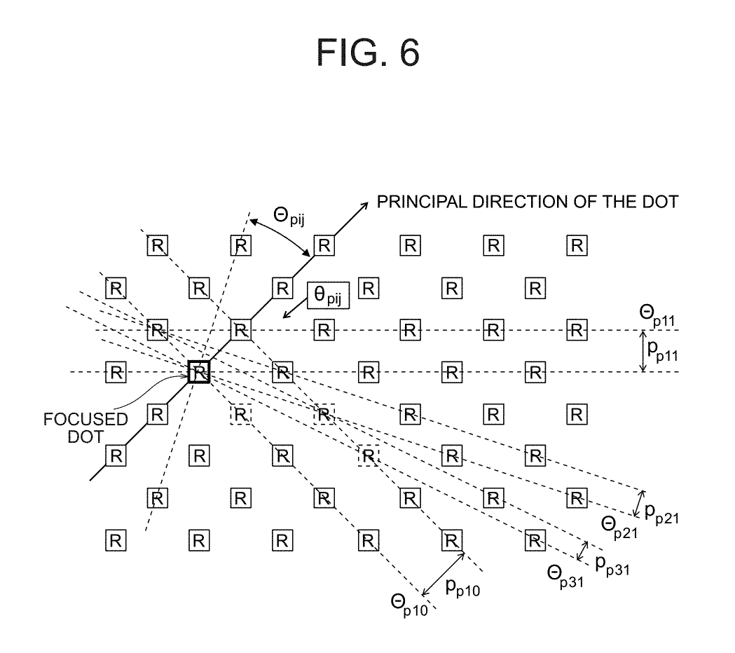

FIG. 6 shows an array of red dots on the surface of an image display device. In FIG. 6, red dots are placed at the lattice points of a two-dimensional square lattice. A certain dot on the surface is noted, and a vector connecting the noted dot and the dot of the same color closest to the noted dot is referred to as a principal direction vector and represented as below.

\vec{Pₐ}

Among vectors connecting the noted dot and the dot closest to the noted dot in dots arrayed in rows that are not parallel to

\vec{Pₐ},

the vector that forms with

\vec{Pₐ}

an angle that is closest to 90 degrees is referred to as a sub-direction vector and represented as below.

\vec{P_{b}}

In FIG. 6, the direction of the principal direction vector is represented as “the principal direction of the dot”.
When definitions

pₐ=|\vec{Pₐ}|,P_{b}=|\vec{P_{b}}|

are given, the relationship

pₐ≦p_{b}

holds. When a vector that is perpendicular to

i\vec{P_{b}}−j\vec{Pₐ},

i and j representing nonnegative integers, and that has a magnitude that is equal to the distance between two adjacent straight lines among the straight lines that correspond to rows of dots arrayed in the direction that is parallel to

i\vec{P_{b}}−j\vec{Pₐ}

is represented as

\vec{Pₚ_{ᵢⱼ}}

the vector can be expressed as below.

$$\vec{{P}_{{p}_{ij}}} = ( \frac{i {\vert {\vec{P}}_{b} \vert}^{2} - j \vec{{P}_{a}} \cdot \vec{{P}_{b}}}{{\vert i \vec{{P}_{b}} - j \vec{{P}_{a}} \vert}^{2}} ) \vec{{P}_{a}} + ( \frac{j {\vert \vec{{P}_{a}} \vert}^{2} - i \vec{{P}_{a}} \cdot \vec{{P}_{b}}}{{\vert i \vec{{P}_{b}} - j \vec{{P}_{a}} \vert}^{2}} ) \vec{{P}_{b}}$$

The above-described distance between two adjacent straight lines is referred to as a spacing between dot rows.
A definition

pₚ_{ᵢⱼ}=|\vec{Pₚ_{ᵢⱼ}}|

is given. pₚᵢⱼ represents a spacing between dot rows.

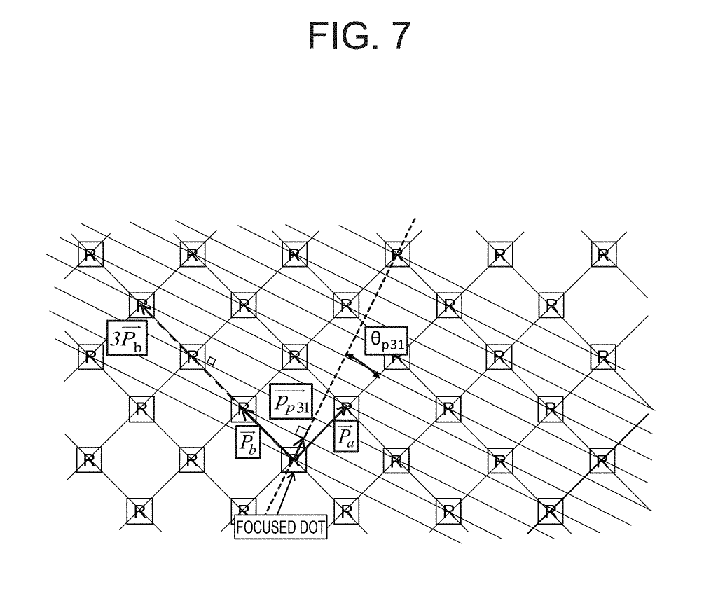

FIG. 7 illustrates

\vec{Pₚ₃₁}

and

θₚ_{₃₁},

for example. In general,

θₚ_{ᵢⱼ}

is an angle that

\vec{Pₐ}

and

\vec{Pₚ_{ᵢⱼ}}

form.

In step S1030 of FIG. 4, a pitch of moiré that is generated by the spacing between dot rows pₚᵢⱼ and the period (pitch) p_{g} of the diffraction grating is obtained

The moiré pitch that is generated by the spacing between dot rows pₚᵢⱼ and the period (pitch) p_{g} of the diffraction grating is represented as below when rotation of the grating is taken into account.

$${p}_{{m}_{ij}} = \frac{1}{\sqrt{{( \frac{{a}_{ij}}{{p}_{{p}_{ij}}} - \frac{{b}_{ij}}{{p}_{g}} cos ( \vert {θ}_{g} - {θ}_{{p}_{ij}} \vert ) )}^{2} + {( \frac{{b}_{ij}}{{p}_{g}} sin ( \vert {θ}_{g} - {θ}_{{p}_{ij}} \vert ) )}^{2}}} \\ {p}_{{m}_{ij}} \qquad ( 3 )$$

represents a moiré pitch that is generated by a group of dot rows that are parallel to one another and represented by

\vec{Pₚ_{ᵢⱼ}}

and the diffraction grating.

θ_{g}

is an angle that

\vec{Pₐ}

and the direction of the diffraction grating form, and

aᵢⱼ,bᵢⱼ

are natural numbers.

The array of dots are π [rad] rotationally symmetrical, and therefore all θₚᵢⱼ that are equal to or greater than 0 [rad] and less than π [rad] and pₚᵢⱼ should be considered. When the array of dots has an additional symmetry axis, angles between a certain symmetry axis and the adjacent symmetry axis alone should be considered.

The resolution of the image display device is twice as great as the dot pitch, and therefore a moiré is always unrecognizable when the relationship

pₘᵢⱼ<2pₚ

holds. In other words, when the relationship

pₘᵢⱼ≧2pₚ (4)

holds, a moiré may become recognizable.

Further, when the period p_{g} of the grating is greater than the dot pitch pₚ, the structure of the grating becomes recognizable, and therefore it is preferable that the relationship

p_{g}<pₚ (5)

holds.

On the other hand, when the relationship θₚᵢⱼ=θ_{g} holds in Expression (3), the moiré pitch pₘᵢⱼ reaches the maximum value for the spacing pₚᵢⱼ between dot rows. In this case, the moiré pitch pₘᵢⱼ is represented by the following expression.

$${p}_{{m}_{ij}} = \frac{1}{\vert \frac{{a}_{ij}}{{p}_{{p}_{ij}}} - \frac{{b}_{ij}}{{p}_{g}} \vert} ( {θ}_{{p}_{ij}} = {θ}_{g} ) \qquad ( 6 )$$

Natural numbers

aᵢⱼ,bᵢⱼ

represent order of moiré,

aᵢⱼ/pₚᵢⱼ

represents an intensity distribution of light and dark portions, and

bᵢⱼ/p_{g}

corresponds to the frequency that is obtained by Fourier transform of phase difference of the diffraction grating. When the shape is sinusoidal, no frequency other than the grating pitch exists, and therefore the case of b=1 alone should be considered. Further, when the denominator of the right side of Expression (6) becomes smaller,

pₘᵢⱼ

becomes greater. Accordingly, natural numbers

aᵢⱼ,bᵢⱼ

that satisfy the following relationship are considered.

$$\frac{{a}_{ij} - \frac{1}{2}}{{b}_{ij}} < \frac{{p}_{{p}_{ij}}}{{p}_{g}} < \frac{{a}_{ij} + \frac{1}{2}}{{b}_{ij}} \qquad ( 7 )$$

The range of dot pitch pₚ that should be considered because moiré is recognizable there is as below from Expression (4) and Expression (6).

$$\frac{1}{\vert \frac{{a}_{ij}}{{p}_{{p}_{ij}}} - \frac{{b}_{ij}}{{p}_{g}} \vert} \geq 2 {p}_{p}$$

In the above-described expression,

aᵢⱼ

is a natural number, and therefore the following relationship holds when Expression (5) is satisfied.

$${p}_{{p}_{ij}} \geq \frac{{a}_{ij}}{\frac{{b}_{ij}}{{p}_{g}} + \frac{1}{2 {p}_{p}}} > \frac{1}{{b}_{ij} + \frac{1}{2}} {p}_{g} \qquad ( 8 )$$

Accordingly, the range of a spacing between dot rows pₚᵢⱼ that should be considered because moiré is recognizable is that satisfying Expression (8).

After all, moiré that is generated by the spacing between dot rows pₚᵢⱼ and the period (pitch) of the diffraction grating p_{g} should be considered for the spacing between dot rows pₚᵢⱼ and

aᵢⱼ,bᵢⱼ

that satisfy Expression (7) and Expression (8).

On the other hand, Expression (3) can be changed to the following expression.

$$\begin{matrix}{( \frac{1}{{p}_{mij}} )}^{2} = {( \frac{{a}_{ij}}{{p}_{{p}_{ij}}} - \frac{{b}_{ij}}{{p}_{g}} cos ( \vert {θ}_{g} - {θ}_{{p}_{ij}} \vert ) )}^{2} + {( \frac{{b}_{ij}}{{p}_{g}} sin ( \vert {θ}_{g} - {θ}_{{p}_{ij}} \vert ) )}^{2} \\ = {( \frac{{a}_{ij}}{{p}_{{p}_{ij}}} )}^{2} + {( \frac{{b}_{ij}}{{p}_{g}} cos ( \vert {θ}_{g} - {θ}_{{p}_{ij}} \vert ) )}^{2} - \\ \frac{2 {a}_{ij} {b}_{ij}}{{p}_{{p}_{ij}} {p}_{g}} cos ( \vert {θ}_{g} - {θ}_{{p}_{ij}} \vert ) + {( \frac{{b}_{ij}}{{p}_{g}} sin ( \vert {θ}_{g} - {θ}_{{p}_{ij}} \vert ) )}^{2} \\ = {( \frac{{a}_{ij}}{{p}_{{p}_{ij}}} )}^{2} + {( \frac{{b}_{ij}}{{p}_{g}} )}^{2} - \frac{2 {a}_{ij} {b}_{ij}}{{p}_{{p}_{ij}} {p}_{g}} cos ( \vert {θ}_{g} - {θ}_{{p}_{ij}} \vert )\end{matrix}$$

Accordingly, when the relationship

pₘᵢⱼ<2pₚ

holds, the following relationship holds.

$${( \frac{{a}_{ij}}{{p}_{{p}_{ij}}} )}^{2} + {( \frac{{b}_{ij}}{{p}_{g}} )}^{2} - \frac{2 {a}_{ij} {b}_{ij}}{{p}_{{p}_{ij}} {p}_{g}} cos ( \vert {θ}_{g} - {θ}_{{p}_{ij}} \vert ) > {( \frac{1}{2 {p}_{p}} )}^{2}$$

Further, the following relationship holds.

$$cos ( \vert {θ}_{g} - {θ}_{{p}_{ij}} \vert ) < \frac{{p}_{{p}_{ij}} {p}_{g}}{2 {a}_{ij} {b}_{ij}} ( {( \frac{{a}_{ij}}{{p}_{{p}_{ij}}} )}^{2} + {( \frac{{b}_{ij}}{{p}_{g}} )}^{2} - {( \frac{1}{2 {p}_{p}} )}^{2} ) \qquad ( 9 )$$

In the above-described expression, the solution of

cos(|θ_{g}−θₚ_{ᵢⱼ}|)

exists when the value of the right side is 1 or less. In other words, the solution exists when the following relationship is satisfied.

$$\frac{{p}_{{p}_{ij}} {p}_{g}}{2 {a}_{ij} {b}_{ij}} ( {( \frac{{a}_{ij}}{{p}_{{p}_{ij}}} )}^{2} + {( \frac{{b}_{ij}}{{p}_{g}} )}^{2} - {( \frac{1}{2 {p}_{p}} )}^{2} ) \leq 1 \\ ( {( \frac{{a}_{ij}}{{p}_{{p}_{ij}}} )}^{2} + {( \frac{{b}_{ij}}{{p}_{g}} )}^{2} - {( \frac{1}{2 {p}_{p}} )}^{2} ) \leq \frac{2 {a}_{ij} {b}_{ij}}{{p}_{{p}_{ij}} {p}_{g}} \\ ( {( \frac{{a}_{ij}}{{p}_{{p}_{ij}}} )}^{2} - \frac{2 {a}_{ij} {b}_{ij}}{{p}_{{p}_{ij}} {p}_{g}} + {( \frac{{b}_{ij}}{{p}_{g}} )}^{2} ) - {( \frac{1}{2 {p}_{p}} )}^{2} \leq 0 \\ {( \frac{{a}_{ij}}{{p}_{{p}_{ij}}} - \frac{{b}_{ij}}{{p}_{g}} )}^{2} - {( \frac{1}{2 {p}_{p}} )}^{2} \leq 0 \\ {( \frac{{a}_{ij}}{{p}_{{p}_{ij}}} - \frac{{b}_{ij}}{{p}_{g}} )}^{2} \leq {( \frac{1}{2 {p}_{p}} )}^{2} \\ \vert \frac{{a}_{ij}}{{p}_{{p}_{ij}}} - \frac{{b}_{ij}}{{p}_{g}} \vert \leq \frac{1}{2 {p}_{p}} \qquad ( 10 )$$

When the right side of Expression (9) is represented as

$$Cij = \frac{{p}_{{p}_{ij}} {p}_{g}}{2 {a}_{ij} {b}_{ij}} ( {( \frac{{a}_{ij}}{{p}_{{p}_{ij}}} )}^{2} + {( \frac{{b}_{ij}}{{p}_{g}} )}^{2} - {( \frac{1}{2 {p}_{p}} )}^{2} )$$

the following relationship holds from Expression (9).

cos(|θ_{g}−θₚ_{ᵢⱼ}|)<Cᵢⱼ

Accordingly, when Expression (10) is satisfied, and the relationship

θ_{g}<θₚ_{ᵢⱼ}−cos⁻¹Cᵢⱼ

or

θ_{g}>θₚ_{ᵢⱼ}+cos⁻¹Cᵢⱼ

holds, the relationship

pₘᵢⱼ<2pₚ

holds, and therefore a moiré is unrecognizable.

Further, when the relationship

Cij>1

holds, the relationship

pₘᵢⱼ<2pₚ

always holds independently of

θ_{g},

and therefore a moiré is unrecognizable.

Accordingly, concerning red dots shown in FIG. 6, a moiré can be made unrecognizable for all values of spacing between dot rows.

Further, red, green and blue dots are placed at the lattice points of a two-dimensional square lattices as shown in FIG. 1. Accordingly, concerning dots of all colors, a moiré can be made unrecognizable for all values of spacing between dot rows, as is the case with red dots.

The value of an angle

θ_{g}

should preferably be set to a value in the range that is the greatest among the obtained ranges in order to reduce an influence of manufacturing error.

The description given above is that concerning a diffraction grating arrayed in one direction. Actually, dots are two-dimensionally arrayed, and therefore a diffraction grating arrayed in plural directions is required. When a diffraction grating arrayed in plural directions is provided on a single plane, an optical filter can advantageously be fixed on a display device.

A diffraction grating arrayed in two directions will be described below. In this case, the diffraction grating should preferably be formed such that it has a diffraction grating in a direction that is close to the direction

\vec{Pₐ}

and another diffraction grating in another direction that is close to the direction

\vec{P_{b}}.

When the relationship

pₐ=p_{b}

holds, the same grating period p_{g} can be used for the grating in each direction.
When the relationship

pₐ≠p_{b}

holds, a separation width is determined for each direction such that the following expressions are satisfied.

δ₁=α₁pₐ,δ₂=α₂p_{b}

Further, the grating periods are determined such that the following expressions are satisfied.

$${p}_{g 1} = \frac{{k}_{1} λ L}{{α}_{1} {p}_{a}}$$

$${p}_{g 2} = \frac{{k}_{2} λ L}{{α}_{2} {p}_{b}}$$

For each grating period, an angle of the grating

θ_{g1},θ_{g2}

is determined according to step S1020 and step S1030 in FIG. 4 in the range of angle in which a moiré can hardly be observed.
When a difference between the two angles is represented as

θ_{gd}=θ_{g2}−θ_{g1}

and the relationship

π/4<θ_{gd}<3π/4

holds, separations in two directions will function. However, the difference should preferably be made equal to the angle that

\vec{Pₐ}

and

\vec{P_{b}}

form.

As described above, a low-pass filter that restrains moiré, the screen-door effect and isolation of a dot can be obtained by determining the depth, the period and the angle of the grating for a given distance L between the display surface and the grating surface and a given dot array according to the flowchart shown in FIG. 4.

A conventional manufacturing method of a combination of an image display device and a diffractive optical filter will be described below.

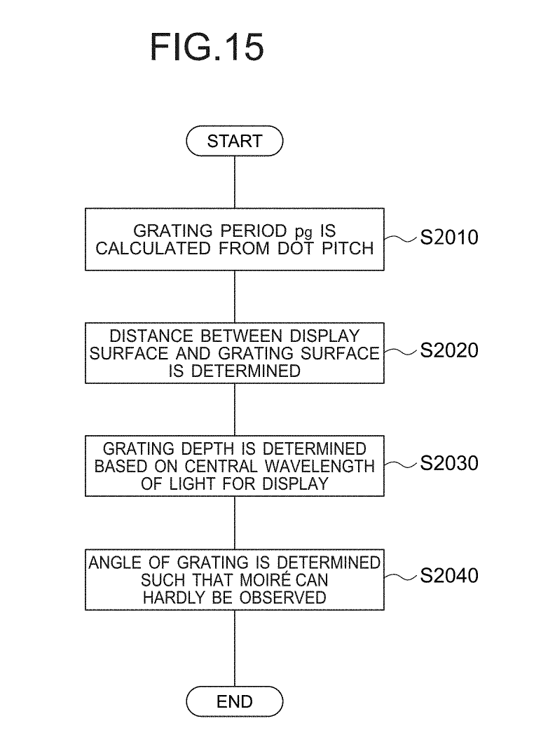

FIG. 15 is a flowchart for illustrating a conventional manufacturing method of a combination of an image display device and a diffractive optical filter.

In step S2010 of FIG. 15, the grating period p_{g} is calculated from the dot pitch pₚ. When the grating is not rotated, the moiré pitch pₘ is represented by the following expression.

$$\frac{1}{{p}_{m}} = \vert \frac{a}{{p}_{p}} - \frac{1}{{p}_{g}} \vert$$

When the relationship between the grating period p_{g} and the moiré pitch pₘ is shown by graphs and the grating period p_{g} is changed, the point corresponding to

p_{g}=pₚ*2/(2M+1)

is the point of intersection between the graph of a=M and the graph of a=M+1, and at the point the moiré pitch pₘ shows the minimum value. M represents a natural number. Using the above-described equation, the grating period p_{g} is calculated from the dot pitch pₚ.

In step S2020 of FIG. 15, the distance between the display surface and the grating surface is determined based on the grating period. More specifically, the distance L between the display surface and the grating surface is obtained by substituting the dot pitch pₚ and the grating period p_{g}.

In step S2030 of FIG. 15, the grating depth is determined based on the central wavelength of lights used for display.

In step S2040 of FIG. 15, the angle of the grating is determined such that a moiré can hardly be observed.

The examples and the comparative examples of the present invention will be described below.

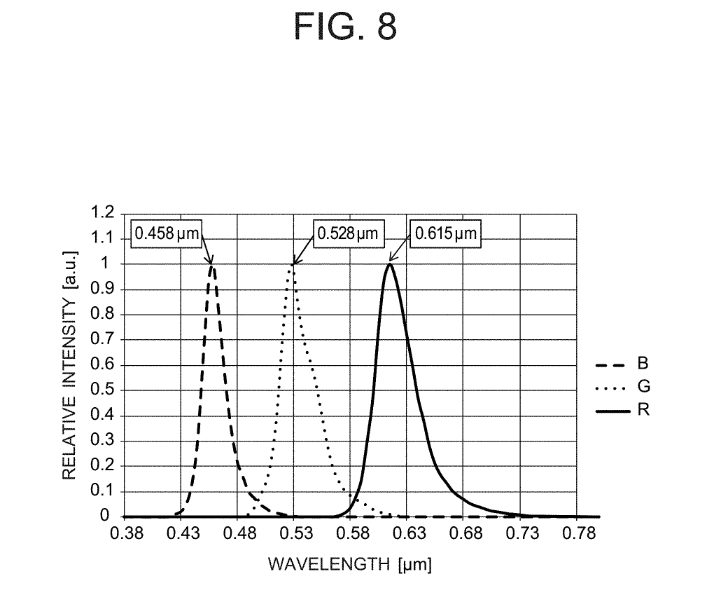

FIG. 8 shows intensity distributions of colors, that is, blue (B), green (G) and red (R) used for image display devices of the examples and the comparative examples. The horizontal axis of FIG. 8 represents wavelength, and the vertical axis of FIG. 8 represents relative intensity in an arbitrary unit.

### Example 1

In the combination of an image display device and a diffractive optical filter according to the present example, a diffraction grating surface 201 is provided on the observer 400 side of the diffractive optical filter 200 as shown in FIG. 3. The diffractive optical filter 200 is made of acrylic resin.

The wavelength at which red light used for display of the display device peaks in intensity is λ=0.615 [μm], and the refractive index at the wavelength is 1.49.

In the present example, Δn=0.49 holds in Expression (1), because lights travel from the synthetic resin to the air (refractive index: 1) at the boundary of the diffraction grating surface. Further, given that k=1 and ε=0.457, d_{g}=0.573 [μm] is obtained.

Tables 1 to 3 show diffraction efficiency of the diffractive optical filter of the Example 1 for red, green and blue lights, respectively. x and y represent the two directions of the diffraction grating. For red light, diffraction efficiency of the zeroth order and that of the ±1st order are equal to one another.

TABLE 1

| | x | | | | | | | | | | |
|---|---|---|---|---|---|---|---|---|---|---|---|
| y | −5 | −4 | −3 | −2 | −1 | 0 | 1 | 2 | 3 | 4 | 5 |
| −5 | 0.000 | 0.000 | 0.000 | 0.000 | 0.000 | 0.000 | 0.000 | 0.000 | 0.000 | 0.000 | 0.000 |
| −4 | 0.000 | 0.000 | 0.000 | 0.000 | 0.000 | 0.000 | 0.000 | 0.000 | 0.000 | 0.000 | 0.000 |
| −3 | 0.000 | 0.000 | 0.000 | 0.000 | 0.001 | 0.001 | 0.001 | 0.000 | 0.000 | 0.000 | 0.000 |
| −2 | 0.000 | 0.000 | 0.000 | 0.002 | 0.014 | 0.014 | 0.014 | 0.002 | 0.000 | 0.000 | 0.000 |
| −1 | 0.000 | 0.000 | 0.001 | 0.014 | 0.090 | 0.090 | 0.090 | 0.014 | 0.001 | 0.000 | 0.000 |
| 0 | 0.000 | 0.000 | 0.001 | 0.014 | 0.090 | 0.090 | 0.090 | 0.014 | 0.001 | 0.000 | 0.000 |
| 1 | 0.000 | 0.000 | 0.001 | 0.014 | 0.090 | 0.090 | 0.090 | 0.014 | 0.001 | 0.000 | 0.000 |
| 2 | 0.000 | 0.000 | 0.000 | 0.002 | 0.014 | 0.014 | 0.014 | 0.002 | 0.000 | 0.000 | 0.000 |
| 3 | 0.000 | 0.000 | 0.000 | 0.000 | 0.001 | 0.001 | 0.001 | 0.000 | 0.000 | 0.000 | 0.000 |
| 4 | 0.000 | 0.000 | 0.000 | 0.000 | 0.000 | 0.000 | 0.000 | 0.000 | 0.000 | 0.000 | 0.000 |
| 5 | 0.000 | 0.000 | 0.000 | 0.000 | 0.000 | 0.000 | 0.000 | 0.000 | 0.000 | 0.000 | 0.000 |

TABLE 2

| | x | | | | | | | | | | |
|---|---|---|---|---|---|---|---|---|---|---|---|
| y | −5 | −4 | −3 | −2 | −1 | 0 | 1 | 2 | 3 | 4 | 5 |
| −5 | 0.000 | 0.000 | 0.000 | 0.000 | 0.000 | 0.000 | 0.000 | 0.000 | 0.000 | 0.000 | 0.000 |
| −4 | 0.000 | 0.000 | 0.000 | 0.000 | 0.000 | 0.000 | 0.000 | 0.000 | 0.000 | 0.000 | 0.000 |
| −3 | 0.000 | 0.000 | 0.000 | 0.001 | 0.002 | 0.001 | 0.002 | 0.001 | 0.000 | 0.000 | 0.000 |
| −2 | 0.000 | 0.000 | 0.001 | 0.006 | 0.026 | 0.013 | 0.026 | 0.006 | 0.001 | 0.000 | 0.000 |
| −1 | 0.000 | 0.000 | 0.002 | 0.026 | 0.111 | 0.055 | 0.111 | 0.026 | 0.002 | 0.000 | 0.000 |
| 0 | 0.000 | 0.000 | 0.001 | 0.013 | 0.055 | 0.027 | 0.055 | 0.013 | 0.001 | 0.000 | 0.000 |
| 1 | 0.000 | 0.000 | 0.002 | 0.026 | 0.111 | 0.055 | 0.111 | 0.026 | 0.002 | 0.000 | 0.000 |
| 2 | 0.000 | 0.000 | 0.001 | 0.006 | 0.026 | 0.013 | 0.026 | 0.006 | 0.001 | 0.000 | 0.000 |
| 3 | 0.000 | 0.000 | 0.000 | 0.001 | 0.002 | 0.001 | 0.002 | 0.001 | 0.000 | 0.000 | 0.000 |
| 4 | 0.000 | 0.000 | 0.000 | 0.000 | 0.000 | 0.000 | 0.000 | 0.000 | 0.000 | 0.000 | 0.000 |
| 5 | 0.000 | 0.000 | 0.000 | 0.000 | 0.000 | 0.000 | 0.000 | 0.000 | 0.000 | 0.000 | 0.000 |

TABLE 3

| | x | | | | | | | | | | |
|---|---|---|---|---|---|---|---|---|---|---|---|
| y | −5 | −4 | −3 | −2 | −1 | 0 | 1 | 2 | 3 | 4 | 5 |
| −5 | 0.000 | 0.000 | 0.000 | 0.000 | 0.000 | 0.000 | 0.000 | 0.000 | 0.000 | 0.000 | 0.000 |
| −4 | 0.000 | 0.000 | 0.000 | 0.000 | 0.000 | 0.000 | 0.000 | 0.000 | 0.000 | 0.000 | 0.000 |
| −3 | 0.000 | 0.000 | 0.000 | 0.002 | 0.005 | 0.001 | 0.005 | 0.002 | 0.000 | 0.000 | 0.000 |
| −2 | 0.000 | 0.000 | 0.002 | 0.014 | 0.040 | 0.007 | 0.040 | 0.014 | 0.002 | 0.000 | 0.000 |
| −1 | 0.000 | 0.000 | 0.005 | 0.040 | 0.112 | 0.020 | 0.112 | 0.040 | 0.005 | 0.000 | 0.000 |
| 0 | 0.000 | 0.000 | 0.001 | 0.007 | 0.020 | 0.003 | 0.020 | 0.007 | 0.001 | 0.000 | 0.000 |
| 1 | 0.000 | 0.000 | 0.005 | 0.040 | 0.112 | 0.020 | 0.112 | 0.040 | 0.005 | 0.000 | 0.000 |
| 2 | 0.000 | 0.000 | 0.002 | 0.014 | 0.040 | 0.007 | 0.040 | 0.014 | 0.002 | 0.000 | 0.000 |
| 3 | 0.000 | 0.000 | 0.000 | 0.002 | 0.005 | 0.001 | 0.005 | 0.002 | 0.000 | 0.000 | 0.000 |
| 4 | 0.000 | 0.000 | 0.000 | 0.000 | 0.000 | 0.000 | 0.000 | 0.000 | 0.000 | 0.000 | 0.000 |
| 5 | 0.000 | 0.000 | 0.000 | 0.000 | 0.000 | 0.000 | 0.000 | 0.000 | 0.000 | 0.000 | 0.000 |

A cover glass is attached to the display device, and the optical distance from the open surface provided with pixels to the surface of the cover glass is 441 [μm]. When the thickness of the diffractive optical filter is 1000 [μm], L=1112 [μm]. When lights of up to the first-order are used, α=0.3544 and the separation width δ is set to 27.36 [μm], p_{g}=25.0 [μm] is obtained from Expression (2). In the present example, the periods (pitches) in the two directions of the diffraction grating are made equal to one another.

The array of pixels of the image display device according to the present example is a diamond-shaped array as shown in FIG. 1. Pitch between red dots and pitch between blue dots are the greatest. The pitch pₚ between red dots or blue dots is represented as pₚ=pₐ=p_{b}=77.2 [μm]. The array of blue dots is the same as that of red dots, and therefore the same calculation can be applied. The dot pitch between green dots is 54.6 [μm], and another calculation than that for red dots is required.

Since pixels are symmetric with respect to three axes, that is, the horizontal axis, the axis in the direction of π/4 [rad], and the vertical axis, θₚₙ should be considered in the range from 0 [rad] to π/4 [μm] alone.

Initially, red (blue) dots are considered. According to step S1020 of FIG. 4,

p_{Pij}=|\vec{P_{Pij}}|

and

θₚ_{ᵢⱼ}

are obtained.

Table 4 shows groups of

p_{Pij}=|\vec{P_{Pij}}|

and

θₚ_{ᵢⱼ}

arranged in the order of magnitude of

p_{Pij}=|\vec{P_{Pij}}|

for red dots. Table 4 shows several groups alone in which magnitude of

p_{Pij}=|\vec{P_{Pij}}|

is relatively great.

TABLE 4

| i | j | θ_{pij, red}[°] | p_{pij, red}[μm] |
|---|---|---|---|
| 1 | 0 | 0.0 | 77.20 |
| 1 | 1 | 45.0 | 54.59 |
| 2 | 1 | 26.6 | 34.52 |
| 3 | 1 | 18.4 | 24.41 |
| 3 | 2 | 33.7 | 21.41 |
| 4 | 1 | 14.0 | 18.72 |
| 4 | 3 | 36.9 | 15.44 |
| 5 | 1 | 11.3 | 15.14 |
| 5 | 2 | 21.8 | 14.34 |
| 5 | 3 | 31.0 | 13.24 |
| 6 | 1 | 9.5 | 12.69 |
| 5 | 4 | 38.7 | 12.06 |
| 7 | 1 | 8.1 | 10.92 |
| 7 | 2 | 15.9 | 10.60 |
| 7 | 3 | 23.2 | 10.14 |

Table 5 similarly shows groups of

p_{Pij}=|\vec{P_{Pij}}|

and

θₚ_{ᵢⱼ}

for green dots. For convenience of moiré pitch calculation, the same reference of measurement of angle

θₚ_{ᵢⱼ}

as that for red dots is employed.

TABLE 5

| I | j | θ_{pij, green}[°] | p_{pij, green}[μm] |
|---|---|---|---|
| 1 | 0 | 45.0 | 54.59 |
| 1 | 1 | 0.0 | 38.60 |
| 2 | 1 | 18.4 | 24.41 |
| 3 | 1 | 26.6 | 17.26 |
| 3 | 2 | 11.3 | 15.14 |
| 4 | 1 | 31.0 | 13.24 |
| 4 | 3 | 8.1 | 10.92 |
| 5 | 1 | 33.7 | 10.71 |
| 5 | 2 | 23.2 | 10.14 |
| 5 | 3 | 14.0 | 9.36 |
| 6 | 1 | 35.5 | 8.97 |
| 5 | 4 | 6.3 | 8.53 |
| 7 | 1 | 36.9 | 7.72 |
| 7 | 2 | 29.1 | 7.50 |
| 7 | 3 | 21.8 | 7.17 |

As described above, the grating period is represented as p_{g}=25.0 [μm], and therefore in Tables 4 and 5, groups of dot rows that are parallel to one another and that satisfy pₚᵢⱼ>16.6 [μm] should be considered. More specifically, the six groups in the first to sixth lines in Table 4 and the four groups in the first to fourth lines in Table 5 should be considered.

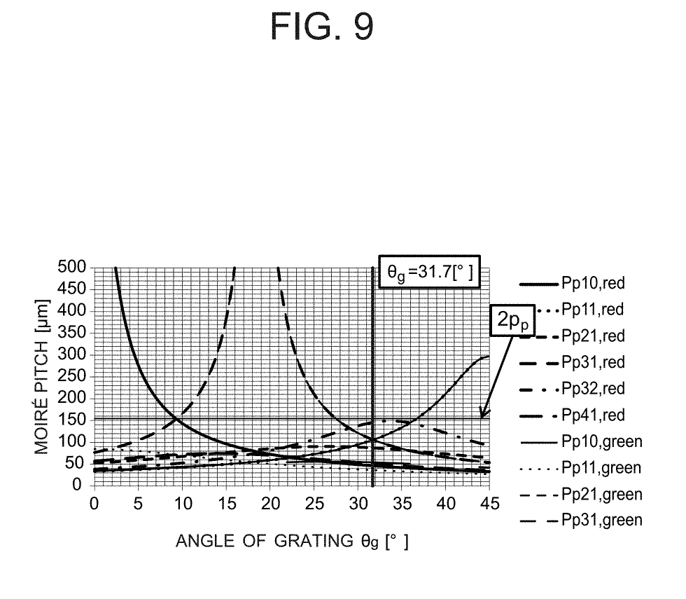

FIG. 9 shows relationships between angle of the grating and moiré pitch for the above-described ten groups in Example 1. The horizontal axis of FIG. 9 indicates angle of the grating, and the vertical axis of FIG. 9 indicates moiré pitch. In FIG. 9, the ranges of θ_{g} in which pₘₘₐₓ<2pₚ is satisfied, that is, the maximum value of moiré pitch is less than twice the dot pitch are from 9.3 [°] to 9.4 [°] and from 27.5 [°] to 36.7 [°]. Under the circumstances, the angle of the grating was set to θ_{g}=31.7 [°] in the greater range.

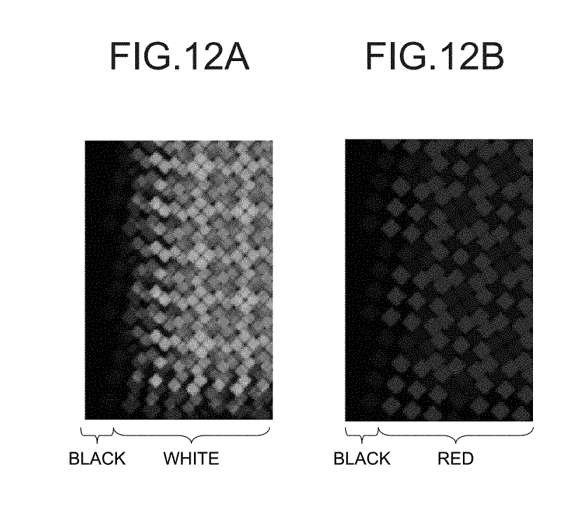

FIGS. 12A and 12B show images displayed by the combination of the image display device and the diffractive optical filter of Example 1. Red dots that are particularly troublesome are sufficiently close to one another, and pixels are evenly separated. Accordingly, isolation of pixels and the screen-door effect are restrained.

In the present example, the diffraction grating surface is placed on the outer side of the filter. The diffraction grating surface may be placed such that it faces the display device. The filter may be made of any material that is colorless and transparent, and is made preferably of synthetic resin such as acrylic resin.

### Example 2

In the combination of an image display device and a diffractive optical filter according to the present example, a diffraction grating surface 201 is provided on the observer 400 side of the diffractive optical filter 200 as shown in FIG. 3. The diffractive optical filter 200 is made of acrylic resin.

The wavelength at which red light used for display of the display device peaks in intensity is λ=0.615 [μm], and the refractive index at the wavelength is 1.49.

In the present example, Δn=0.49 holds in Expression (1), because lights travel from the synthetic resin to the air (refractive index: 1) at the boundary of the diffraction grating surface. Further, given that k=3 and ε=1.212, d_{g}=1.520 [μm] is obtained.

Tables 6 to 8 show diffraction efficiency of the diffractive optical filter of the Example 2 for red, green and blue lights, respectively. x and y represent the two directions of the diffraction grating. For red light, diffraction efficiency of the zeroth order, that of the ±2nd order and that of the ±3rd order are substantially equal to one another.

TABLE 6

| | x | | | | | | | | | | |
|---|---|---|---|---|---|---|---|---|---|---|---|
| y | −5 | −4 | −3 | −2 | −1 | 0 | 1 | 2 | 3 | 4 | 5 |
| −5 | 0.000 | 0.001 | 0.002 | 0.002 | 0.000 | 0.002 | 0.000 | 0.002 | 0.002 | 0.001 | 0.000 |
| −4 | 0.001 | 0.004 | 0.010 | 0.010 | 0.000 | 0.010 | 0.000 | 0.010 | 0.010 | 0.004 | 0.001 |
| −3 | 0.002 | 0.010 | 0.030 | 0.030 | 0.000 | 0.028 | 0.000 | 0.030 | 0.030 | 0.010 | 0.002 |
| −2 | 0.002 | 0.010 | 0.030 | 0.030 | 0.000 | 0.028 | 0.000 | 0.030 | 0.030 | 0.010 | 0.002 |
| −1 | 0.000 | 0.000 | 0.000 | 0.000 | 0.000 | 0.000 | 0.000 | 0.000 | 0.000 | 0.000 | 0.000 |
| 0 | 0.002 | 0.010 | 0.028 | 0.028 | 0.000 | 0.026 | 0.000 | 0.028 | 0.028 | 0.010 | 0.002 |
| 1 | 0.000 | 0.000 | 0.000 | 0.000 | 0.000 | 0.000 | 0.000 | 0.000 | 0.000 | 0.000 | 0.000 |
| 2 | 0.002 | 0.010 | 0.030 | 0.030 | 0.000 | 0.028 | 0.000 | 0.030 | 0.030 | 0.010 | 0.002 |
| 3 | 0.002 | 0.010 | 0.030 | 0.030 | 0.000 | 0.028 | 0.000 | 0.030 | 0.030 | 0.010 | 0.002 |
| 4 | 0.001 | 0.004 | 0.010 | 0.010 | 0.000 | 0.010 | 0.000 | 0.010 | 0.010 | 0.004 | 0.001 |
| 5 | 0.000 | 0.001 | 0.002 | 0.002 | 0.000 | 0.002 | 0.000 | 0.002 | 0.002 | 0.001 | 0.000 |

TABLE 7

| | x | | | | | | | | | | |
|---|---|---|---|---|---|---|---|---|---|---|---|
| y | −5 | −4 | −3 | −2 | −1 | 0 | 1 | 2 | 3 | 4 | 5 |
| −5 | 0.001 | 0.004 | 0.006 | 0.002 | 0.002 | 0.004 | 0.002 | 0.002 | 0.006 | 0.004 | 0.001 |
| −4 | 0.004 | 0.013 | 0.021 | 0.007 | 0.005 | 0.013 | 0.005 | 0.007 | 0.021 | 0.013 | 0.004 |
| −3 | 0.006 | 0.021 | 0.034 | 0.011 | 0.008 | 0.021 | 0.008 | 0.011 | 0.034 | 0.021 | 0.006 |
| −2 | 0.002 | 0.007 | 0.011 | 0.003 | 0.003 | 0.007 | 0.003 | 0.003 | 0.011 | 0.007 | 0.002 |
| −1 | 0.002 | 0.005 | 0.008 | 0.003 | 0.002 | 0.005 | 0.002 | 0.003 | 0.008 | 0.005 | 0.002 |
| 0 | 0.004 | 0.013 | 0.021 | 0.007 | 0.005 | 0.013 | 0.005 | 0.007 | 0.021 | 0.013 | 0.004 |
| 1 | 0.002 | 0.005 | 0.008 | 0.003 | 0.002 | 0.005 | 0.002 | 0.003 | 0.008 | 0.005 | 0.002 |
| 2 | 0.002 | 0.007 | 0.011 | 0.003 | 0.003 | 0.007 | 0.003 | 0.003 | 0.011 | 0.007 | 0.002 |
| 3 | 0.006 | 0.021 | 0.034 | 0.011 | 0.008 | 0.021 | 0.008 | 0.011 | 0.034 | 0.021 | 0.006 |
| 4 | 0.004 | 0.013 | 0.021 | 0.007 | 0.005 | 0.013 | 0.005 | 0.007 | 0.021 | 0.013 | 0.004 |
| 5 | 0.001 | 0.004 | 0.006 | 0.002 | 0.002 | 0.004 | 0.002 | 0.002 | 0.006 | 0.004 | 0.001 |

TABLE 8

| | x | | | | | | | | | | |
|---|---|---|---|---|---|---|---|---|---|---|---|
| y | −5 | −4 | −3 | −2 | −1 | 0 | 1 | 2 | 3 | 4 | 5 |
| −5 | 0.006 | 0.013 | 0.009 | 0.000 | 0.009 | 0.001 | 0.009 | 0.000 | 0.009 | 0.013 | 0.006 |
| −4 | 0.013 | 0.025 | 0.018 | 0.000 | 0.018 | 0.002 | 0.018 | 0.000 | 0.018 | 0.025 | 0.013 |
| −3 | 0.009 | 0.018 | 0.012 | 0.000 | 0.013 | 0.002 | 0.013 | 0.000 | 0.012 | 0.018 | 0.009 |
| −2 | 0.000 | 0.000 | 0.000 | 0.000 | 0.000 | 0.000 | 0.000 | 0.000 | 0.000 | 0.000 | 0.000 |
| −1 | 0.009 | 0.018 | 0.013 | 0.000 | 0.014 | 0.002 | 0.014 | 0.000 | 0.013 | 0.018 | 0.009 |
| 0 | 0.001 | 0.002 | 0.002 | 0.000 | 0.002 | 0.000 | 0.002 | 0.000 | 0.002 | 0.002 | 0.001 |
| 1 | 0.009 | 0.018 | 0.013 | 0.000 | 0.014 | 0.002 | 0.014 | 0.000 | 0.013 | 0.018 | 0.009 |
| 2 | 0.000 | 0.000 | 0.000 | 0.000 | 0.000 | 0.000 | 0.000 | 0.000 | 0.000 | 0.000 | 0.000 |
| 3 | 0.009 | 0.018 | 0.012 | 0.000 | 0.013 | 0.002 | 0.013 | 0.000 | 0.012 | 0.018 | 0.009 |
| 4 | 0.013 | 0.025 | 0.018 | 0.000 | 0.018 | 0.002 | 0.018 | 0.000 | 0.018 | 0.025 | 0.013 |
| 5 | 0.006 | 0.013 | 0.009 | 0.000 | 0.009 | 0.001 | 0.009 | 0.000 | 0.009 | 0.013 | 0.006 |

A cover glass is attached to the display device, and the optical distance from the open surface provided with pixels to the surface of the cover glass is 441 [μm]. When the thickness of the diffractive optical filter is 1000 [μm], L=1112 [μm]. When lights of up to the third-order are used, α=0.350, and the separation width δ is set to 27.02 [μm], p_{g}=75.94 [μm] is obtained from Expression (2). In the present example, the periods (pitches) in the two directions of the diffraction grating are made equal to one another.

As described above, the grating period is represented as p_{g}=75.94 [μm], and therefore groups of dot rows that are parallel to one another and that satisfy pₚᵢⱼ>50.6 [μm] should be considered.

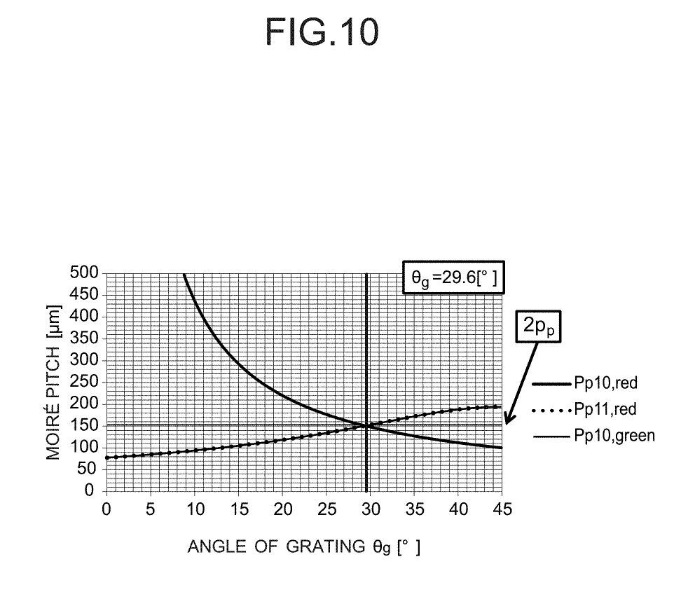

FIG. 10 shows relationships between angle of the grating and moiré pitch for three groups to be considered in Example 2. The horizontal axis of FIG. 10 indicates angle of the grating, and the vertical axis of FIG. 10 indicates moiré pitch. In FIG. 10, the range of θ_{g} in which pₘₘₐₓ<2pₚ is satisfied, that is, the maximum value of moiré pitch is less than twice the dot pitch is from 28.7 [°] to 30.5 [°]. Under the circumstances, the angle of the grating was set to θ_{g}=29.6 [°].

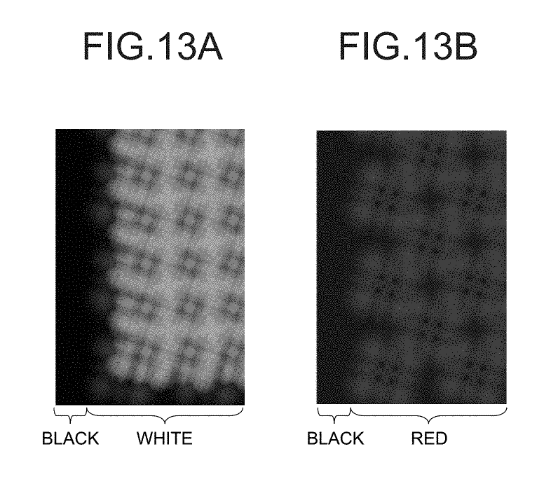

FIGS. 13A and 13B show images displayed by the combination of the image display device and the diffractive optical filter of Example 2. Isolation of pixels and the screen-door effect are restrained, and deterioration of pixels is also restrained.

### Comparative Example 1

When dot pitch pp=77.2 [μm] is given as is the case with Example 1, and M=2 is given in the expression

p_{g}=pₚ*2/(2M+1),

the grating period pg=30.88 [μm] is obtained according to step S2010 of FIG. 15.

When α=0.3544 and δ=27.36 [μm] are given as is the case with Example 1, L=1374 [μm] is obtained using Expression (2) according to step S2020 of FIG. 15. Accordingly, the thickness of the diffractive optical filter is 1390 [μm].

The grating depth was set to the same value as that of Example 1.

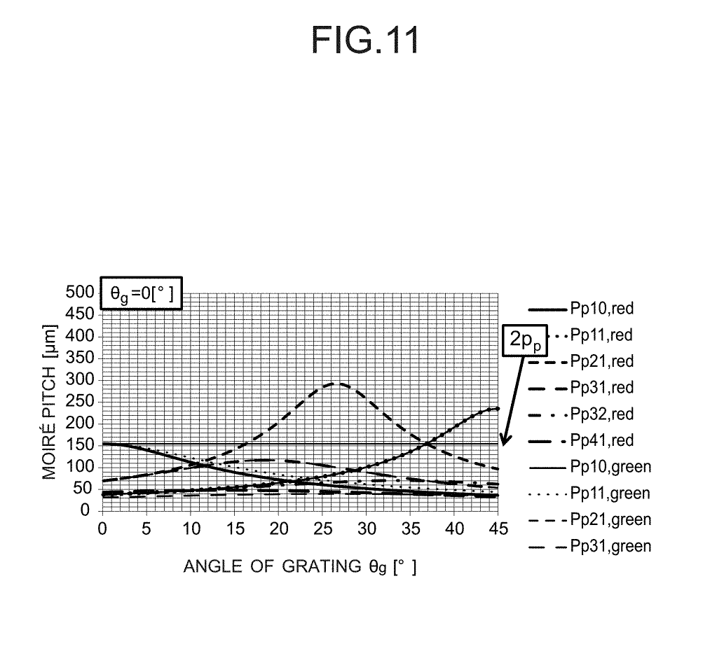

FIG. 11 shows relationships between angle of the grating and moiré pitch for ten groups to be considered in Comparative Example 1. The horizontal axis of FIG. 11 indicates angle of the grating, and the vertical axis of FIG. 11 indicates moiré pitch.

As shown in FIG. 11, moiré pitch can be restrained when the angle of the grating is set to 0 degree. However, in the present comparative example, the thickness of the grating is determined by the grating period, and cannot be determined freely.

### Comparative Example 2

As is the case with Example 1, the thickness of the diffractive optical filter was set to 1000 [μm], and the grating was formed such that it has two directions that are orthogonal to each other, and p_{g}=25.0 [μm] and θ_{g}=31.7 [°] are satisfied. The grating depth is designed for the wavelength of green (A=0.528 [μm]) according to step S2030 of FIG. 15, and dg=0.488 [μm] is obtained.

Tables 9 to 11 show diffraction efficiency of the diffractive optical filter of the Comparative Example 2 for red, green and blue lights, respectively. x and y represent the two directions of the diffraction grating. For red light, diffraction efficiency of the ±1st order is smaller than that of the zeroth order.

TABLE 9

| | x | | | | | | | | | | |
|---|---|---|---|---|---|---|---|---|---|---|---|
| y | −5 | −4 | −3 | −2 | −1 | 0 | 1 | 2 | 3 | 4 | 5 |
| −5 | 0.000 | 0.000 | 0.000 | 0.000 | 0.000 | 0.000 | 0.000 | 0.000 | 0.000 | 0.000 | 0.000 |
| −4 | 0.000 | 0.000 | 0.000 | 0.000 | 0.000 | 0.000 | 0.000 | 0.000 | 0.000 | 0.000 | 0.000 |
| −3 | 0.000 | 0.000 | 0.000 | 0.000 | 0.000 | 0.001 | 0.000 | 0.000 | 0.000 | 0.000 | 0.000 |
| −2 | 0.000 | 0.000 | 0.000 | 0.001 | 0.007 | 0.012 | 0.007 | 0.001 | 0.000 | 0.000 | 0.000 |
| −1 | 0.000 | 0.000 | 0.000 | 0.007 | 0.065 | 0.111 | 0.065 | 0.007 | 0.000 | 0.000 | 0.000 |
| 0 | 0.000 | 0.000 | 0.001 | 0.012 | 0.111 | 0.190 | 0.111 | 0.012 | 0.001 | 0.000 | 0.000 |
| 1 | 0.000 | 0.000 | 0.000 | 0.007 | 0.065 | 0.111 | 0.065 | 0.007 | 0.000 | 0.000 | 0.000 |
| 2 | 0.000 | 0.000 | 0.000 | 0.001 | 0.007 | 0.012 | 0.007 | 0.001 | 0.000 | 0.000 | 0.000 |
| 3 | 0.000 | 0.000 | 0.000 | 0.000 | 0.000 | 0.001 | 0.000 | 0.000 | 0.000 | 0.000 | 0.000 |
| 4 | 0.000 | 0.000 | 0.000 | 0.000 | 0.000 | 0.000 | 0.000 | 0.000 | 0.000 | 0.000 | 0.000 |
| 5 | 0.000 | 0.000 | 0.000 | 0.000 | 0.000 | 0.000 | 0.000 | 0.000 | 0.000 | 0.000 | 0.000 |

TABLE 10

| | x | | | | | | | | | | |
|---|---|---|---|---|---|---|---|---|---|---|---|
| y | −5 | −4 | −3 | −2 | −1 | 0 | 1 | 2 | 3 | 4 | 5 |
| −5 | 0.000 | 0.000 | 0.000 | 0.000 | 0.000 | 0.000 | 0.000 | 0.000 | 0.000 | 0.000 | 0.000 |
| −4 | 0.000 | 0.000 | 0.000 | 0.000 | 0.000 | 0.000 | 0.000 | 0.000 | 0.000 | 0.000 | 0.000 |
| −3 | 0.000 | 0.000 | 0.000 | 0.000 | 0.001 | 0.001 | 0.001 | 0.000 | 0.000 | 0.000 | 0.000 |
| −2 | 0.000 | 0.000 | 0.000 | 0.002 | 0.014 | 0.014 | 0.014 | 0.002 | 0.000 | 0.000 | 0.000 |
| −1 | 0.000 | 0.000 | 0.001 | 0.014 | 0.090 | 0.090 | 0.090 | 0.014 | 0.001 | 0.000 | 0.000 |
| 0 | 0.000 | 0.000 | 0.001 | 0.014 | 0.090 | 0.089 | 0.090 | 0.014 | 0.001 | 0.000 | 0.000 |
| 1 | 0.000 | 0.000 | 0.001 | 0.014 | 0.090 | 0.090 | 0.090 | 0.014 | 0.001 | 0.000 | 0.000 |
| 2 | 0.000 | 0.000 | 0.000 | 0.002 | 0.014 | 0.014 | 0.014 | 0.002 | 0.000 | 0.000 | 0.000 |
| 3 | 0.000 | 0.000 | 0.000 | 0.000 | 0.001 | 0.001 | 0.001 | 0.000 | 0.000 | 0.000 | 0.000 |
| 4 | 0.000 | 0.000 | 0.000 | 0.000 | 0.000 | 0.000 | 0.000 | 0.000 | 0.000 | 0.000 | 0.000 |
| 5 | 0.000 | 0.000 | 0.000 | 0.000 | 0.000 | 0.000 | 0.000 | 0.000 | 0.000 | 0.000 | 0.000 |

TABLE 11

| | x | | | | | | | | | | |
|---|---|---|---|---|---|---|---|---|---|---|---|
| y | −5 | −4 | −3 | −2 | −1 | 0 | 1 | 2 | 3 | 4 | 5 |
| −5 | 0.000 | 0.000 | 0.000 | 0.000 | 0.000 | 0.000 | 0.000 | 0.000 | 0.000 | 0.000 | 0.000 |
| −4 | 0.000 | 0.000 | 0.000 | 0.000 | 0.000 | 0.000 | 0.000 | 0.000 | 0.000 | 0.000 | 0.000 |
| −3 | 0.000 | 0.000 | 0.000 | 0.001 | 0.002 | 0.001 | 0.002 | 0.001 | 0.000 | 0.000 | 0.000 |
| −2 | 0.000 | 0.000 | 0.001 | 0.006 | 0.025 | 0.013 | 0.025 | 0.006 | 0.001 | 0.000 | 0.000 |
| −1 | 0.000 | 0.000 | 0.002 | 0.025 | 0.110 | 0.056 | 0.110 | 0.025 | 0.002 | 0.000 | 0.000 |
| 0 | 0.000 | 0.000 | 0.001 | 0.013 | 0.056 | 0.029 | 0.056 | 0.013 | 0.001 | 0.000 | 0.000 |
| 1 | 0.000 | 0.000 | 0.002 | 0.025 | 0.110 | 0.056 | 0.110 | 0.025 | 0.002 | 0.000 | 0.000 |
| 2 | 0.000 | 0.000 | 0.001 | 0.006 | 0.025 | 0.013 | 0.025 | 0.006 | 0.001 | 0.000 | 0.000 |
| 3 | 0.000 | 0.000 | 0.000 | 0.001 | 0.002 | 0.001 | 0.002 | 0.001 | 0.000 | 0.000 | 0.000 |
| 4 | 0.000 | 0.000 | 0.000 | 0.000 | 0.000 | 0.000 | 0.000 | 0.000 | 0.000 | 0.000 | 0.000 |
| 5 | 0.000 | 0.000 | 0.000 | 0.000 | 0.000 | 0.000 | 0.000 | 0.000 | 0.000 | 0.000 | 0.000 |

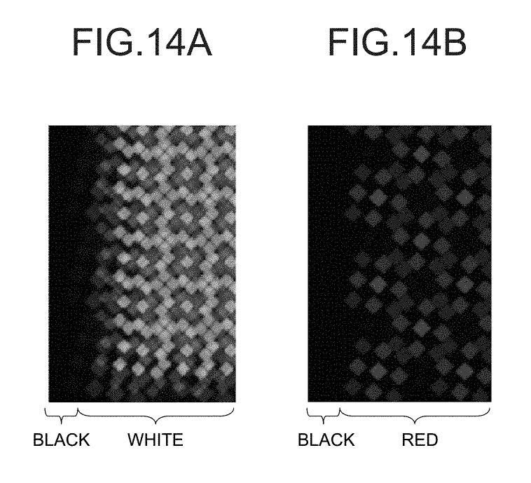

FIGS. 14A and 14B show images displayed by the combination of the image display device and the diffractive optical filter of Comparative Example 2. In FIG. 14B, red dots are not separated to a sufficient extent, and isolated dots can be observed at the boundary between the red area and the black area. It is considered that this is caused by the above-described fact that for red light, intensity of the ±1st order light is smaller than that of the zeroth order light.

What is claimed is:

1. A combination of a color image display device and a diffractive optical filter, the color image display device including dots arrayed two-dimensionally on a first surface, the diffractive optical filter including a diffraction grating provided on a second surface that is parallel to the first surface, and a cross section in each direction of the diffraction grating being of substantially sinusoidal shape,
wherein the depth d_{g} of the sinusoidal shape is represented as
$${d}_{g} = \frac{ɛ λ}{Δ n}$$
where λ represents the wavelength at which intensity of red light used for the image display device reaches the peak, Δn represents a difference in refractive index at λ of the grating, and ε represents a constant, the period p_{g} of the sinusoidal shape is represented as
$${p}_{g} = \frac{k λ L}{α {p}_{p}}$$
$$0.32 < α < 0.39$$
$$5 {P}_{p} < L$$
where L represents a distance between the first surface and the second surface, pₚ represents a dot pitch of a color that is the greatest among the colors, the dot pitch referring to the minimum distance between two adjacent dots of the same color, k is 1 or 3, α represents a constant, when k=1, the relationship
0.445≦ε≦0.465
holds, and when k=3, the relationship
1.15≦ε≦1.25
holds.

2. A combination of a color image display device and a diffractive optical filter according to claim 1, wherein the wavelength λ at which intensity of red light used for the image display device reaches the peak is in the following range.
0.600 [μm]≦λ≦0.660 [μm]

3. A combination of a color image display device and a diffractive optical filter according to claim 1, wherein the diffractive optical filter is made of synthetic resin and is molded through injection molding.

4. A combination of a color image display device and a diffractive optical filter, the color image display device including dots arrayed two-dimensionally on a first surface, the diffractive optical filter including a diffraction grating provided on a second surface that is parallel to the first surface, and a cross section in each direction of the diffraction grating being of substantially sinusoidal shape,
wherein when a certain dot of a certain color on the first surface is noted, and a vector connecting the noted dot and the dot of the same color closest to the noted dot is referred to as a principal direction vector and represented as
\vec{Pₐ},
among vectors connecting the noted dot and the dot closest to the noted dot in the dots arrayed in rows that are not parallel to
\vec{Pₐ},
the vector that forms an angle that is closest to 90 degrees with
\vec{Pₐ}
is referred to as a sub-direction vector and represented as
\vec{P_{b}},
a vector that is perpendicular to
i\vec{P_{b}}−j\vec{Pₐ},
i and j representing integers that are prime, and that has a magnitude that is equal to the distance between two adjacent straight lines among the straight lines that correspond to rows of dots arrayed in the direction that is parallel to
i\vec{P_{b}}−j\vec{Pₐ}
is represented as
i\vec{P_{b}}−j\vec{Pₐ}
the vector can be expressed as
$$\vec{{P}_{{p}_{ij}}} = ( \frac{i \vert \vec{{P}_{b}} {\vert}^{2} - j \vec{{P}_{a}} \cdot \vec{{P}_{p}}}{{\vert i \vec{{P}_{b}} - j \vec{{P}_{a}} \vert}^{2}} ) \vec{{P}_{a}} + ( \frac{j {\vert \vec{{P}_{a}} \vert}^{2} - i \vec{{P}_{a}} \cdot \vec{{P}_{b}}}{{\vert i \vec{{P}_{b}} - j \vec{{P}_{a}} \vert}^{2}} ) \vec{{P}_{b}} , \\ {p}_{{p}_{ij}} = \vert \vec{{P}_{{p}_{ij}}} \vert ,$$
Cij is defined as
$${C}_{ij} = \frac{{p}_{{p}_{ij}} {p}_{g}}{2 {a}_{ij} {b}_{ij}} ( {( \frac{{a}_{ij}}{{p}_{{p}_{ij}}} )}^{2} + {( \frac{{b}_{ij}}{{p}_{g}} )}^{2} - {( \frac{1}{2 {p}_{p}} )}^{2} ) ,$$
for any
\vec{Pₚ_{ᵢⱼ}}
that has
aᵢⱼ,bᵢⱼ
that satisfy
$$\frac{1}{2 {p}_{p}} \geq \vert \frac{{a}_{ij}}{{p}_{{p}_{ij}}} - \frac{{b}_{ij}}{{p}_{g}} \vert$$
pₚ representing a dot pitch, that is, the minimum distance between two adjacent dots of the color and
aᵢⱼ,bᵢⱼ
representing natural numbers, and
p_{g}
representing the period of the diffraction grating,
an angle that
\vec{Pₐ}
and each direction of the diffraction grating form is represented as
θ_{g},
and an angle that
\vec{Pₐ}
and
\vec{Pₚ_{ᵢⱼ}}
form is represented as
θₚ_{ᵢⱼ},
the combination is configured such that
θ_{g}<θₚ_{ᵢⱼ}−cos⁻¹Cᵢⱼ
or
θ_{g}>θₚ_{ᵢⱼ}+cos⁻¹Cᵢⱼ
is satisfied.

5. A combination of a color image display device and a diffractive optical filter according to claim 4, wherein the number of
\vec{Pₚ_{ᵢⱼ}}
that has
aᵢⱼ,bᵢⱼ
that satisfy
$$\frac{1}{2 {p}_{p}} \geq \vert \frac{{a}_{ij}}{{p}_{{p}_{ij}}} - \frac{{b}_{ij}}{{p}_{g}} \vert$$
is three or more.

6. A combination of a color image display device and a diffractive optical filter according to claim 4, wherein the number of
\vec{Pₚ_{ᵢⱼ}}
that has
aᵢⱼ,bᵢⱼ
that satisfy
$$\frac{1}{2 {p}_{p}} \geq \vert \frac{{a}_{ij}}{{p}_{{p}_{ij}}} - \frac{{b}_{ij}}{{p}_{g}} \vert$$
is ten or more.

7. A manufacturing method of a combination of a color image display device and a diffractive optical filter, the color image display device including dots arrayed two-dimensionally on a first surface, the diffractive optical filter including a diffraction grating provided on a second surface that is parallel to the first surface, and a cross section in each direction of the diffraction grating being of substantially sinusoidal shape, wherein the method includes the steps of
determining a period and a depth of the sinusoidal shape the diffraction grating;
calculating
$$\vec{{P}_{{p}_{ij}}} = ( \frac{i \vert \vec{{P}_{b}} {\vert}^{2} - j \vec{{P}_{a}} \cdot \vec{{P}_{b}}}{{\vert i \vec{{P}_{b}} - j \vec{{P}_{a}} \vert}^{2}} ) \vec{{P}_{a}} + ( \frac{j {\vert \vec{{P}_{a}} \vert}^{2} - i \vec{{P}_{a}} \cdot \vec{{P}_{b}}}{{\vert i \vec{{P}_{b}} - j \vec{{P}_{a}} \vert}^{2}} ) \vec{{P}_{b}} ,$$
when a certain dot of a certain color on the first surface is noted, and a vector connecting the noted dot and the dot of the same color closest to the noted dot is referred to as a principal direction vector and represented as
\vec{Pₐ},
among vectors connecting the noted dot and the dot closest to the noted dot in the dots arrayed in rows that are not parallel to
\vec{Pₐ},
the vector that forms an angle that is closest to 90 degrees with
\vec{Pₐ}
is referred to as a sub-direction vector and represented as
\vec{P_{b}},
a vector that is perpendicular to
i\vec{P_{b}}−j\vec{Pₐ},
i and j representing integers that are prime, and that has a magnitude that is equal to the distance between two adjacent straight lines among the straight lines that correspond to rows of dots arrayed in the direction that is parallel to
i\vec{P_{b}}−j\vec{Pₐ}
is represented as
\vec{Pₚ_{ᵢⱼ}}, and
determining
θ_{g}
that satisfies
θ_{g}<θ_{P}_{ᵢⱼ}−cos⁻¹Cᵢⱼ
or
θ_{g}>θₚ_{ᵢⱼ}+cos⁻¹Cᵢⱼ
where Cij is defined as
$${C}_{ij} = \frac{{p}_{{p}_{ij}} {p}_{g}}{2 {a}_{ij} {b}_{ij}} ( {( \frac{{a}_{ij}}{{p}_{{p}_{ij}}} )}^{2} + {( \frac{{b}_{ij}}{{p}_{g}} )}^{2} - {( \frac{1}{2 {p}_{p}} )}^{2} ) ,$$
for any
\vec{Pₚ_{ᵢⱼ}}
that has
aᵢⱼ,bᵢⱼ
that satisfy
$$\frac{1}{2 {p}_{p}} \geq \vert \frac{{a}_{ij}}{{p}_{{p}_{ij}}} - \frac{{b}_{ij}}{{p}_{g}} \vert$$
pₚ representing a dot pitch, that is, the minimum distance between two adjacent dots of the color
aᵢⱼ,bᵢⱼ
representing natural numbers,
p_{g}
representing the period of the diffraction grating, and
p_{P}_{ᵢⱼ}=|\vec{P_{P}_{ᵢⱼ}}|,
an angle that
\vec{Pₐ}
and each direction of the diffraction grating form is represented as
θ_{g},
and an angle that
\vec{Pₐ}
and
\vec{Pₚ_{ᵢⱼ}}
form is represented as
θₚ_{ᵢⱼ}.
